(19) United States
(12) Patent Application Publication
(10) Pub. No.: US 2004/0004358 A1
(43) Pub. Date: Jan. 8, 2004

(54) Motor vehicle door lock or hatch lock

(76) Inventors: Horst Arlt, Wuelfrath (DE); Bernd Weyerstall, Wuppertal (DE); Stefan Josten, Remscheid (DE)

Correspondence Address: NIXON PEABODY, LLP, 401 9TH STREET, NW, SUITE 900, WASINGTON, DC, 20004-2128, US

(21) Appl. No.: 10/429,251

(22) Filed: May 5, 2003

(30) Foreign Application Priority Data
May 8, 2002 (DE) 102 20 732.1

(51) Int. Cl. E05C 3/06

(52) U.S. Cl. 292/235

(57) ABSTRACT

A motor vehicle door lock or hatch lock with a housing with an entry slot for the striker, with latching elements, such as a latch and ratchet located in the housing, with at least one Bowden cable (3) which emerges on a narrow side of the housing for mechanical actuation of the latching elements, and optionally, with an electric drive for the latching elements which is located in the housing, especially the ratchet, the housing being made essentially symmetrical to its center plane and the entry slot being open on both flat sides of the housing, parallel to the center plane, thus allowing selective installation of the motor vehicle lock for left entry, right entry or middle entry of the striker. The Bowden cable (3) is pivotally mounted on the housing (1) in a rotary mount (8) and the Bowden cable (3) is guided away from the housing (1) via the rotary mount (8) in an arc by means of an arc-shaped guide (9).

### BACKGROUND OF THE INVENTION

1. Field of the Invention

The invention relates to a motor vehicle door lock or hatch lock with a housing having an entry slot for the striker, with latching elements, such as a latch and ratchet located in the housing, with at least one Bowden cable which emerges on a narrow side of the housing for mechanical actuation of the latching elements, the housing being made essentially symmetrical relative to its middle plane and the inlet slot being open on both flat sides parallel to the middle plane, thus allowing selective installation of the motor vehicle lock for left entry, right entry or middle entry of the striker.

The expression motor vehicle lock as used below is intended to include door locks and hatch locks.

2. Description of Related Art

The known motor vehicle lock underlying the invention (WO 97/13942 A2 and corresponding U.S. Pat. No. 6,050,117) is characterized in that, as a result of the symmetry of the outside housing, this motor vehicle lock can be used selectively for left entry or right entry or for middle entry of the striker in a rear hatch or a rear door. Thus, small series also become economically producible since the total number of the motor vehicle lock of the required type is doubled or quadrupled.

In the known motor vehicle lock, the basic concept is further optimized in that the housing is largely encapsulated. There is largely complete sealing of the interior of the housing against the entry of moisture

For special embodiments and developments of the known motor vehicle lock, reference should be made to the aforementioned WO 97/13942 A2 and corresponding U.S. Pat. No. 6,050,117, with disclosure contents which are also made the disclosure contents of these application documents.

The known motor vehicle lock is inherently an electric lock, specifically, in the housing, it has an electric drive for the ratchet which raises the ratchet when a corresponding control command arrives. In this motor vehicle lock, mechanical redundancy is implemented in that there is an additional mechanical actuation possibility by means of a Bowden cable, for example, from a corresponding lock cylinder. The Bowden cable enters the housing via a sealed entry fitting on the narrow side of the housing. Specifically, in the known motor vehicle lock, there is another Bowden cable, one cable being used for outside opening in an emergency, and the other cable for inside actuation in an emergency.

The arrangement of the entry fitting for the Bowden cable on the narrow side of the motor vehicle lock in the above explained prior art makes it possible to guide the Bowden cable in one direction or the other away from the housing of the motor vehicle lock. In this way, the Bowden cable can be installed rather expediently in the direction which is desired at the time for the various installation possibilities of the motor vehicle lock.

### SUMMARY OF THE INVENTION

The primary object of the present invention is to further improve the known motor vehicle lock with an essentially symmetrical housing and with a Bowden cable which emerges on the narrow side with respect to the installation versions.

The aforementioned object is achieved by the claimed motor vehicle lock by the features that the Bowden cable is pivotally mounted on the housing in a rotary mount and the Bowden cable is guided from the rotary mount in an arc away from the housing by means of a guide which has an arcuate shape. There is a rotary mount of the Bowden cable, more exactly of the jacket of the Bowden cable, on the housing in conjunction with a guide for the Bowden cable which is arc-shaped and guides the cable proceeding from this rotary mount in a relatively narrow arc away from the housing. Therefore, the linkage of the Bowden cable to the housing of the motor vehicle lock is made such that the Bowden cable is allowed to turn subsequently by means of its guide relative to the housing. The Bowden cable can thus be aligned to the housing in a manner predetermined by the guide.

In addition, the rotary mount and the guide offer a preferred possibility for inserting the Bowden cable sealed into the housing, for sealing the jacket of the Bowden cable towards the housing and allowing the core to enter the interior of the housing.

The invention is explained in detailed below with reference to the accompanying drawings which show one embodiment by way of example only.

### BRIEF DESCRIPTION OF THE DRAWINGS

FIG. 1 is a perspective view schematically showing a motor vehicle lock in accordance with the invention which can be used selectively as a side door lock and as a hatch lock, the Bowden cable being turned to the right by means of the guide,

FIG. 2 is a perspective view schematically showing the motor vehicle lock from FIG. 1 with the Bowden cable now turned to the left by means of the guide,

FIG. 3 is an enlarged perspective view schematically showing the guide of the motor vehicle lock with part of the Bowden cable.

### DETAILED DESCRIPTION OF THE INVENTION

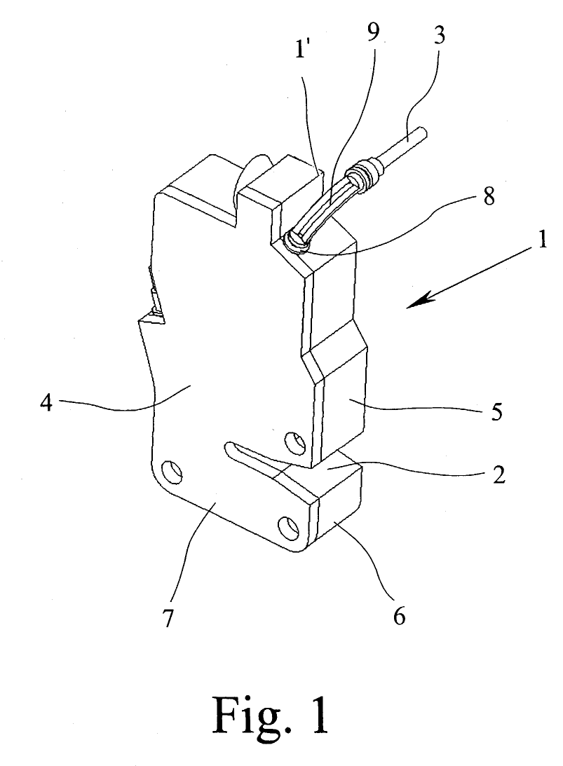

FIGS. 1 to 3 shows a motor vehicle door lock or hatch lock, abbreviated a motor vehicle lock below. It is characterized by the advantages explained in the general part of the specification, specially it can be used universally for right entry, for left entry or for middle entry (for example in a rear door).

This motor vehicle lock shows a housing 1 with an entry slot 2 for a striker (locking pin, locking wedge) which is not shown here and which can be arranged on the counterpiece of the body. In particular, reference should be made to the initially explained prior art according to WO 97/13942 A2 and corresponding U.S. Pat. No. 6,050,117 for the structure of such a motor vehicle lock.

In the housing 1 of such a motor vehicle lock, there are necessarily latching elements, such as a latch and ratchet, or in another embodiment, a catch. Since the housing 1 is shown closed in the drawing, the latching elements within the housing 1 cannot be seen.

On the narrow side of the housing 1, a Bowden cable 3 emerges. The Bowden cable 3 is used for mechanical actuation of the latching elements, especially the opening actuation of the ratchet. Actuation can also mean the movement of a lever element and simply indirect actuation of the ratchet or also motion of the safety lever. It is not necessary for the motor vehicle lock to be an electric lock, therefore, for there to be an electric drive for the latching elements, especially the ratchet, in the housing 1. However, it is preferred that the motor vehicle lock of the invention be an electric lock with such an electric drive for actuating the ratchet or the catch, and in which the Bowden cable 3 is used for emergency mechanical actuation, therefore mechanical redundancy.

The housing 1 is made essentially symmetrical to its center plane and forms two flat sides 4 in which the inlet slot 2 is realized, and the aforementioned narrow sides 5. Essentially symmetrically to the center plane, the overall configuration of the housing 1 does not describe division into individual segments of the housing. This embodiment shows specifically, in this respect, a housing 1 which is not made symmetrical to the middle plane at all, since this housing 1 is composed of a housing shell 6 (which forms one flat side 4 and essentially all narrow sides 5) and a housing cover 7 which forms the other flat side 4 of the housing 1. This assembly of various parts however changes nothing in the housing 1 in the overall execution having the above explained essential symmetry to the center plane which makes it possible to ensure the versatile installation capacity at different points in the motor vehicle body.

It is important that the inlet slot 2 on the two flat sides 4 parallel to the center plane is open and thus allows selective installation of the lock for left entry, right entry or middle entry of the striker.

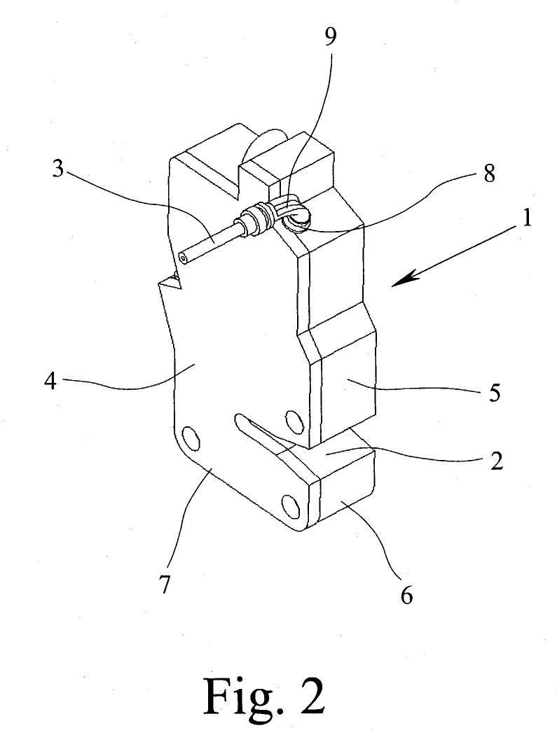

This embodiment now shows that the Bowden cable 3 on the housing 1 is pivotally mounted in a rotary mount 8 and that the Bowden cable 3 is guided proceeding from the rotary mount 8 in an arc away from the housing 1 by means of a guide 9 which is arc-shaped. By means of the guide 9, the Bowden cable 3, in a given manner, can be guided in an arc with a relatively small arc radius, especially an arc radius of roughly 10 to 100 mm, preferably roughly 10 to 30 mm, away from the rotary mount 8 which is the exit site for the cable from the housing 1. FIG. 1 shows the installation version, for example, for the driver's side door, FIG. 2 shows the installation version for the passenger's side door in which the Bowden cable 3 is guided from the housing 1 in exactly the opposite direction from that shown in FIG. 1, away from the housing center plane. This is enabled by the fact that the Bowden cable 3 can be turned accordingly by means of the guide 9 located on the rotary mount 8.

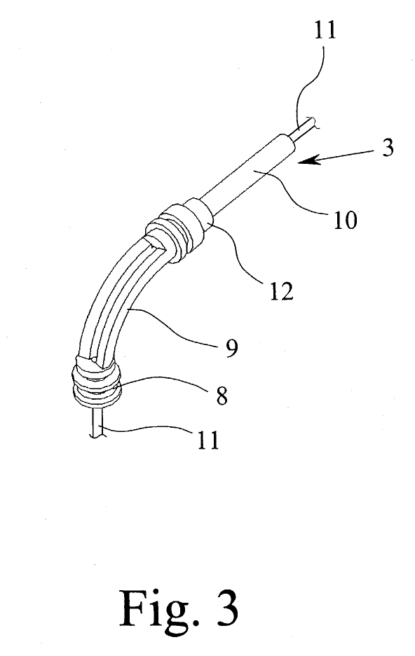

The Bowden cable 3 has a jacket 10 and a core 11 which runs in the jacket 10, as dictated by the system. Both are shown in FIG. 3. The ability of the Bowden cable 3 to turn relative to the housing 1 makes it a good idea for the core 11 of the Bowden cable 3 to be pivotally coupled within the housing 1 to the engagement point there, especially to the ratchet.

Furthermore, the embodiment shown otherwise illustrates that the Bowden cable 3 emerges out of the housing 1, parallel to the center plane and is guided away from the center plane. However, this is not essential. For a less symmetrical configuration of the housing 1, the Bowden cable could also emerge inclined relative to the center plane.

The symmetry of the housing 1 relative to the center plane, as this embodiment shows, has otherwise nothing to do with the arrangement of the rotary mount 8 for the Bowden cable 3 on the narrow side 5 of the housing 1. In contrast, here the Bowden cable 3 is arranged asymmetrically relative to the center plane. The Bowden cable 3 must “arrive” at the proper location within the housing 1 with the core 11. This determines the connecting point on the housing 1, therefore the position of the rotary mount 8.

This embodiment shows a preferred embodiment as the guide 9 is permanently connected to the rotary mount 8. In this embodiment, for example, they are made as one piece. This corresponds especially well with the guide 9 and the rotary mount 8 being made of plastic.

Other materials could also be used, especially a composite material could be recommended, for example, a plastically bendable metal which is coated with plastic.

It could also be recommended that the rotary mount 8 be provided with a rotary angle limit. However, the embodiment shown illustrates another approach, specifically; the housing 1 is provided with a rotary angle limit relative to the rotary mount 8. The projection 1′ on the housing 1, which is shown in FIGS. 1 and 2, prevents rotation of the Bowden cable 3 beyond the positions shown in FIGS. 1 and 2. With this rotary angle limit, the core 11 can also be fixedly coupled within the housing 1 because the ability of the core 11 to move in the jacket 10 of the Bowden cable 3 is sufficient for the adjustment of the Bowden cable 3.

The preferred embodiment shown makes it otherwise clear that the guide 9, here, forms a permanently set arc, an arc of roughly 90°. A permanently set arc is especially expedient in a one-piece plastic component of the guide 9 and the rotary mount 8. In another version, it can be provided that the guide 9 is, to a certain extent bendable in the desired angle, therefore can be plastically deformed in this respect. Then, the angle in which the guide 9 guides the Bowden cable 3 can also be re-adjusted on site during installation.

The Bowden cable 3 could be inserted as such into the guide 9 which is preferably open on one side and could preferably be locked in it. This embodiment, however, shows another configuration which is characterized in that the guide 9, in this section, forms or elongates the jacket of the Bowden cable 3 and itself has a mount 12 for the jacket 10 of the Bowden cable 3. The mount 12 for the jacket 10 on the guide 9 is especially apparent in FIG. 3. This mount 12, for the corresponding moisture seal of the motor vehicle lock, should have or form the moisture seal. This means that there is a corresponding sealing element here, for example, an O-ring here or the surfaces of the mount 12 and of the jacket 10 are made such that they form the necessary moisture seal in interaction with one another. The latter can be achieved with the corresponding surface configuration, especially an corresponding elastomer coating. Optionally, a mechanical screw connection or the like can also be accomplished.

In the same way as for the mount 12, with a corresponding configuration of the guide 9, the rotary mount 8 can also have or form a moisture seal in order to prevent entry of moisture into the interior of the housing 1 at this point as well.

What is claimed is:

1. Motor vehicle closure lock comprising:
a housing with broad and narrow sides, the housing being symmetric with respect to a center plane thereof and having an entry slot for a striker, the entry slot being open at both broad sides parallel to the center plane of the housing for allowing selective installation of the motor vehicle lock for left entry, right entry or middle entry of the striker,
latching elements located in the housing,
at least one Bowden cable for mechanical actuation of the latching elements, said Bowden cable emerging on a narrow side of the housing the housing, and
a rotary mount pivotally mounted on the housing and having an arc-shaped guide extending therefrom, the Bowden cable being guided through the rotary mount in an arc away from the housing by means of the arc-shaped guide.

2. Motor vehicle door lock as claimed in claim 1, wherein a core of the Bowden cable is pivotally coupled within the housing to an engagement point there.

3. Motor vehicle door lock as claimed in claim 1, wherein the Bowden cable emerges from the housing substantially parallel to the center plane of the housing and then is guided away from the center plane.

4. Motor vehicle door lock as claimed in claim 1, wherein the guide is permanently connected to the rotary mount

5. Motor vehicle door lock as claimed in claim 1, wherein the guide is made in one piece with the rotary mount.

6. Motor vehicle door lock as claimed in claim 4, wherein at least one of the guide and the rotary mount is made of plastic.

7. Motor vehicle door lock as claimed in claim 1, wherein at least one of the guide and the rotary mount is made of plastic.

8. Motor vehicle door lock as claimed in claim 1, wherein one of the rotary mount and the housing is provided with a rotary angle limit for limiting rotation of the Bowden cable relative to the housing.

9. Motor vehicle door lock as claimed in claim 8, wherein said rotary angle limit is formed by exterior portions of said housing.

10. Motor vehicle door lock as claimed in claim 1, wherein the guide forms a permanently specified arc of roughly 90°.

11. Motor vehicle door lock as claimed in claim 1, wherein the guide is bendable to a certain extent for adjusting extent of said arc.

12. Motor vehicle door lock as claimed in claim 1, wherein the guide is a molded part which is open on one side and into which the Bowden cable is insertable.

13. Motor vehicle door lock as claimed in claim 6, wherein the guide is a molded part which is open on one side and into which the Bowden cable is insertable.

14. Motor vehicle door lock as claimed in claim 7, wherein the guide is a molded part which is open on one side and into which the Bowden cable is insertable.

15. Motor vehicle door lock as claimed in claim 1, wherein the guide forms or elongates a section of a jacket of the Bowden cable and itself has a mount for the jacket of the Bowden cable.

16. Motor vehicle door lock as claimed in claim 12, wherein the guide forms or elongates a section of a jacket of the Bowden cable and itself has a mount for the jacket of the Bowden cable.

17. Motor vehicle door lock as claimed in claim 13, wherein the guide forms or elongates a section of a jacket of the Bowden cable and itself has a mount for the jacket of the Bowden cable.

18. Motor vehicle door lock as claimed in claim 14, wherein the guide forms or elongates a section of a jacket of the Bowden cable and itself has a mount for the jacket of the Bowden cable.

19. Motor vehicle door lock as claimed in claim 15, wherein the mount for the jacket has or forms a moisture seal.

20. Motor vehicle door lock as claimed in claim 16, wherein the mount for the jacket has or forms a moisture seal.

21. Motor vehicle door lock as claimed in claim 17, wherein the mount for the jacket has or forms a moisture seal.

22. Motor vehicle door lock as claimed in claim 18, wherein the mount for the jacket has or forms a moisture seal.

23. Motor vehicle door lock as claimed in claim 1, wherein the rotary mount for the jacket has or forms a moisture seal.
